(19) United States
(12) Patent Application Publication
(10) Pub. No.: US 2010/0212454 A1
(43) Pub. Date: Aug. 26, 2010

(54) Bike pedal assembly structure

(76) Inventor: Chung-Han Wang, Tainan (TW)

Correspondence Address: BACON & THOMAS, PLLC, 625 SLATERS LANE, FOURTH FLOOR, ALEXANDRIA, VA, 22314-1176, US

(21) Appl. No.: 12/585,017

(22) Filed: Sep. 1, 2009

(30) Foreign Application Priority Data
Feb. 20, 2009 (TW) 098105529

(51) Int. Cl. G05G 1/30

(52) U.S. Cl. 74/560

(57) ABSTRACT

A bike pedal assembly structure is disclosed, which involves a bracing joint connecting to a crank, and a pivotal shaft of the pedal and a control bar are penetrated into a joining cylinder of the bracing joint for a joining. By depressing the pressing head of the control bar, the pivotal shaft of the pedal and the control bar can be dismounted from the joining cylinder. The pedal can even be mounted to the same structure in a reverse position for the prevention of the possibilities in forgetting to place it somewhere or even in losing it. Since the store of the pedals is located at the space between the cranks of both sides, which means deadly save the space.

### BACKGROUND OF THE INVENTION

1. Field of the Invention

The present invention relates generally to a bike pedal assembly structure and more specifically to one handy in dismounting the pedal from the crank, and in mounting the pedal to the same structure in a reverse position for the prevention of the possibilities in forgetting to place it somewhere or even losing it, minimizing occupied volume and saving transport and stock space.

2. Description of the Prior Art

A bike pedal is a component that is mounted on the bike for being stepped by a foot to advance the bike. The common structure of the bike pedal has a “pedal surface” (can be any shape) and a “pivotal shaft” extending from its lateral. In assembly, the pivotal shaft is pin-jointed to the outer end of a crank which is extended from each of two opposite sides at front chain wheel. And the pedal surfaces are located at both sides of the bike respectively, which are perpendicular to the bike frame for the purpose of being stepped with ease.

The prior art bikes (especially the folding type of bike) have offered the folding type of the pedal for saving transport and stock space (folding the pedal to overlap the crank during the occasions of not in use), or the assembly structure that is easy in mounting or dismounting (handy in dismounting the pedal for being placed somewhere anytime). No matter the pedal is a folding type or easy in mounting or dismounting, the only concern is to save the space occupied by the pedal. However, the means to bend the pedal has disadvantages such as complicated structure and laborious operation. As for the situation of placing the dismounted pedal somewhere (store it), the disadvantages about it including forgetting it (taking time to find it out later on) or even losing it (couldn't find it any more), which substantially demonstrates the assembly structures of the prior art pedals are far from ideal for use.

This inventor engaged in the bike research and manufacturing profession notices the existence of the aforesaid drawbacks. Through advanced research and development, he conceived the idea for the improvement, where the aforesaid drawbacks of the bike pedal are capable of being improved, and eventually the long endeavors gave birth to this invention.

### SUMMARY OF THE INVENTION

The objective of this invention is to provide a bike pedal assembly structure which is handy in dismounting the pedal from the crank.

The other objective of this invention is to provide a bike pedal that is available for being mounted to the same structure in a reverse position for the prevention of the possibilities in forgetting to place it somewhere or even in losing it, which can substantially minimize the occupied volume and save transport and stock space.

To achieve the aforementioned objects, the bike pedal assembly structure of this invention comprises a pedal, a bracing joint and a crank, where the pedal comprises a pedal surface, a pivotal shaft extended from a side thereto. The pivotal shaft is provided with an inward cylindrical hollow and a fixing hole on its inner wall. The pedal further comprises a control bar, a springy member and a fixing member, where the control bar is provided with an elevated position on its bar and a relatively low holding notch, where the front end of the bar is set up into a pressing head; the springy member is placed into the cylindrical hollow of the pivotal shaft first, followed by the insertion of the control bar until a touch with the springy member, and a alignment between the fixing hole and either the elevated position of the control bar or the holding notch. The fixing member is then available to be placed from the external of the fixing hole to have its bottom portion touch the elevated position or the holding notch, and an extra work being activated to shrink the opening rim of the fixing hole inward for the prevention of the fixing member from coming off the fixing hole;

The bracing joint is short cylindrical in shape, having an outer threaded section extending from its side for the joining purpose, and having a joining cylinder penetrating through its interior, where a fixing bore is set up on its internal wall;

The crank has its one end mounted on the bike, while the other end has an inner threaded cylinder for the joining purpose;

The outer threaded section of the bracing joint is screwed into the inner threaded cylinder of the crank for a joining, and the pivotal shaft penetrates the joining cylinder of the bracing joint for a joining. The fixing member is lifted by the elevated position of the control bar to enter the fixing bore of the bracing joint for a joining. By means of depressing of the pressing head, the holding notch of the control bar accommodates the fixing member, which is then ready to dismount the pivotal shaft of the pedal and the control bar apart from the joining cylinder of the bracing joint.

In the aforesaid invention, the springy member may be a bar-typed spring.

In the aforesaid invention, the fixing member may be a spherical steel ball.

In the aforesaid invention, the control bar is provided with a block at its bottom end.

In the aforesaid invention, the length of the joining cylinder of the bracing joint is better to accommodate completely the pivotal shaft of the pedal.

In the aforesaid invention, the fixing bore is inserted by a plug.

In the aforesaid invention, the fixing bore is provided with inner threads at its inner wall, followed by the screwing of an outer-threaded stopper into the fixing bore, to have the internal end of the stopper prop tightly the fixing member, which further makes the fixing member prop tightly the control bar for a immobilizing.

### BRIEF DESCRIPTION OF THE DRAWINGS

FIG. 1 is a three-dimensional exploded view of the embodiment of this invention;

FIG. 2 is an assembled sectional and major-parts exploded view of the embodiment of this invention;

FIG. 3 is an assembled sectional enlarged view of a partial structure of the embodiment of this invention;

FIGS. 4-6 are schematic views for the motion steps of manipulating the pivotal shaft of the pedal to insert the joining cylinder of the bracing joint of the embodiment of this invention;

FIG. 7 is a schematic diagram of an exterior insertion of the pedal of the embodiment of this invention;

FIG. 8 is a schematic diagram of the motion of dismounting of the pedal of the embodiment of this invention;

FIG. 9 is a schematic diagram of an interior insertion of the pedal of the embodiment of this invention;

FIG. 10 is a schematic diagram of the completion of the exterior insertion mode of the bike pedal;

FIG. 11 is a schematic diagram of the completion of the interior insertion mode of the bike pedal;

FIG. 12 is a schematic structural view of an added plug of the embodiment of this invention;

FIG. 13 is a schematic structural view of an added stopper of the embodiment of this invention; and

FIG. 14 is a three-dimensional view of the stopper of the embodiment of this invention.

### DETAILED DESCRIPTION OF THE INVENTION

To achieve the foregoing objects of the present invention, the techniques adopted and the achievable functioning are detailed described with reference to the following preferred exemplified embodiments and the accompanying drawings, which helps a thorough comprehension of the present invention.

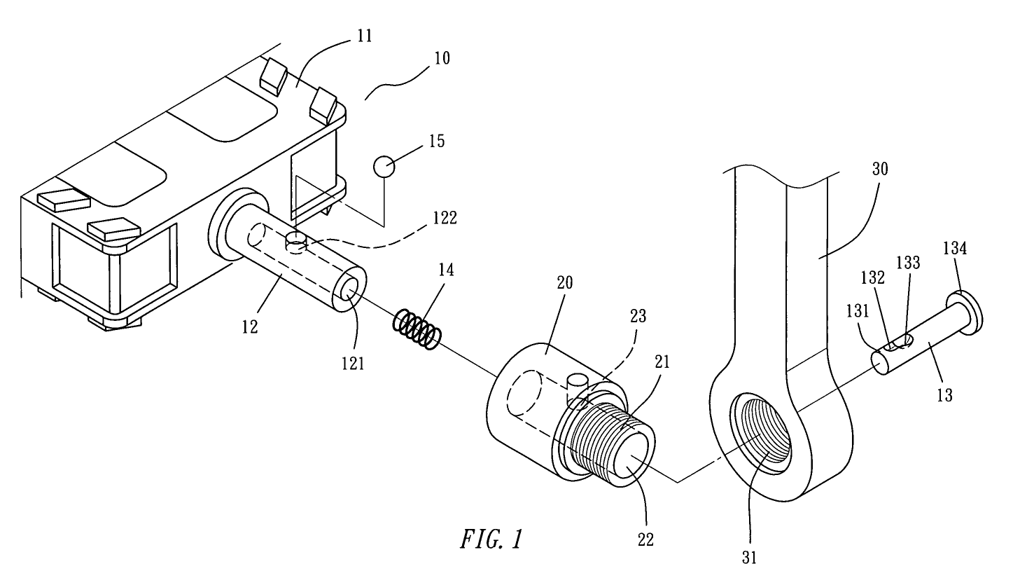

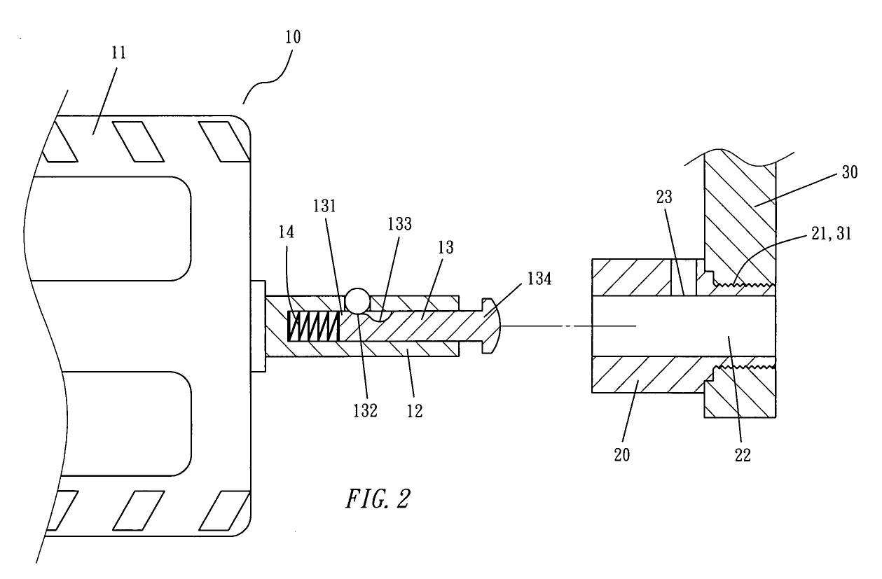

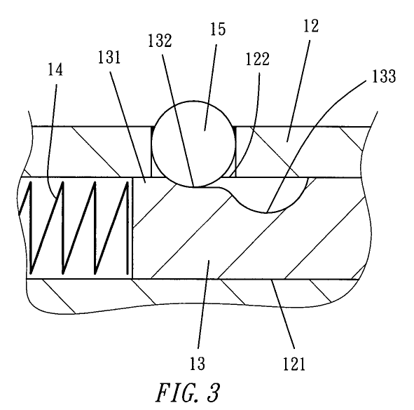

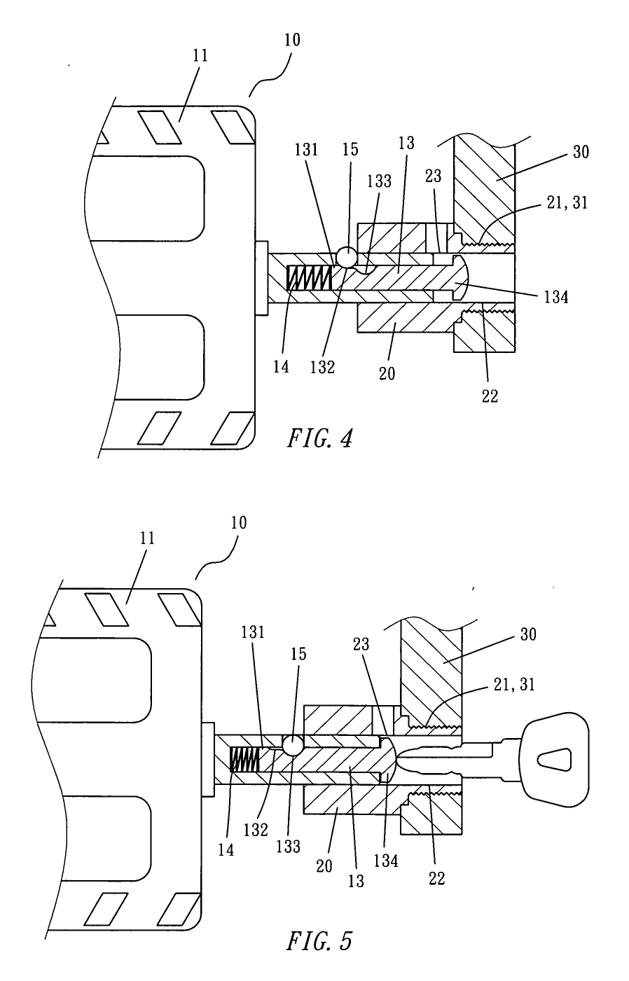

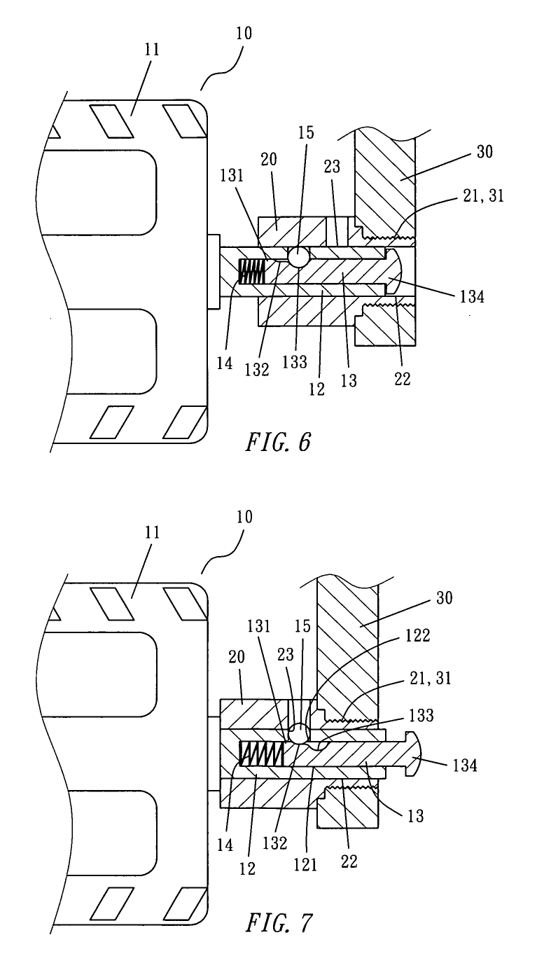

Referring to FIGS. 1 & 2, the embodiment of this invention is a bike pedal assembly structure, comprising a pedal 10, a bracing joint 20 and a crank 30; wherein the pedal 10 comprises a pedal surface 11 (may be any shape), a pivotal shaft 12 extended from a side thereto; where the pivotal shaft 12 is provided with an inward cylindrical hollow 121 and a fixing hole 122 from its inner wall through to the outside; and the pedal 10 further comprises a control bar 13, a springy member 14 (may be bar spring in shape) and a fixing member 15 (may be a spherical steel ball), where the control bar 13 is a rod that is inserted into the cylindrical hollow 121 and the rod is provided with a block 131 at its bottom end and an elevated position 132 at its side. A relatively low holding notch 133 is set aside. And the other (front) end of the rod is set up into a pressing head 134. In assembly (referring to FIGS. 2 & 3), the springy member 14 is placed into the cylindrical hollow 121 of the pivotal shaft 12 first, followed by the insertion of the control bar 13 in the bottom end with the block 131 until a touch with the springy member 14. By depressing on the pressing head 134, an alignment is set between the fixing hole 122 and either the elevated position 132 of the control bar 13 or the holding notch 133. The fixing member 15 is placed from the external of the fixing hole 122 to have its bottom portion touch the elevated position 132 or the holding notch 133 (FIG. 3 is an enlarged schematic diagram to depict the touch of the elevated position 132), and an extra destructive work is activated to shrink the opening rim of the fixing hole 122 inward for the prevention of the fixing member 15 from coming off the fixing hole 122. But there is still some portion to exceed the opening rim of the fixing hole 122. And it could move inward. Therefore, with a depressing on the pressing head 134 (by a rod or finger) to align the holding notch 133 of the control bar 13 with the fixing member 15 (referring to FIGS. 5 & 8), the bottom part of the fixing member 15 will fall in the holding notch 133. With a prior design on its size, the top part of the fixing member 15 is kept not to exceed the exterior side of the cylindrical hollow 121. Once the pressing head 134 is being released (referring to FIGS. 7 & 9), the control bar 13 is being pushed to move outward by the elastic force of the springy member 14, which lifts the fixing member 15 by the elevated position 132 of the control bar 13. Meanwhile, the block 131 of the control bar 13 is also hindered by the fixing member 15, so that the control bar 13 is unable to be dismounted from the cylindrical hollow 121.

Referring to FIGS. 1 & 2, the bracing joint 20 is short cylindrical in shape, having an outer threaded section 21 extending from its side for the joining purpose, and having a joining cylinder 22 penetrating through its interior, where a fixing bore 23 is set up on its internal wall, and the length of the joining cylinder 22 is better to accommodate completely the pivotal shaft 12 of the pedal 10. The crank 30, a prior art component of the bikes, has its one end mounted on the bike, while the other end has an inner-threaded cylinder 31 for the joining purpose. In assembly (shown in FIG. 2), the outer threaded section 21 of the bracing joint 20 is screwed into the inner threaded cylinder 31 of the crank 30 for a joining. By hand holding the pedal surface 11 of the pedal 10, the pivotal shaft 12 is penetrated into the joining cylinder 22 of the bracing joint 20 for a joining (say an exterior insertion mode). In the process of the insertion, the steps of the operation are as follows:
1.) As the pivotal shaft 12 is inserted into the joining cylinder 22 of the bracing joint 20, as shown in FIG. 4, the portion of the springy member 14 that exceeds the opening of the fixing hole 122 will touch the inner wall of the joining cylinder 22, which barricades the pivotal shaft 12 from moving ahead. By using a rod (key, the most often stuff carried, or a screw driver, a chopstick, a branch and the like) shown in FIG. 5, a user can press the pressing head 134 from the other opening of the joining cylinder 22, which moves the control bar 13 inward, to align the holding notch 133 of the control bar 13 with the fixing member 15, and the fixing member 15 at that moment falls in the holding notch 133 for a stay (shown in FIG. 5), which enables the pivotal shaft 12 to move ahead successively (shown in FIG. 6). At this moment, it is available to release the depressing on the pressing head 134.
2.) Once the pivotal shaft 12 moves to the deepest location of the joining cylinder 22 shown in FIG. 7, the fixing member 15 is then aligned with the fixing bore 23 of the bracing joint 20. By using the elastic force of the springy member 14 to push the control bar 13, the control bar 13 will move outward, which enables the elevated position 132 lifts the fixing member 15 to enter the fixing bore 23 for a stay. At this moment it is not available to extract the pivotal shaft 12 of the pedal 10 away from the joining cylinder 22 of the bracing joint 20, to enable the pedal 10 available for use.

Therefore, as long as the cranks 30 at both sides of a bike are mounted with a bracing joint 20 and inserted by the pivotal shaft 12 of the pedal 10 for a joining, the pedals 10 are then ready to be used for bike riding.

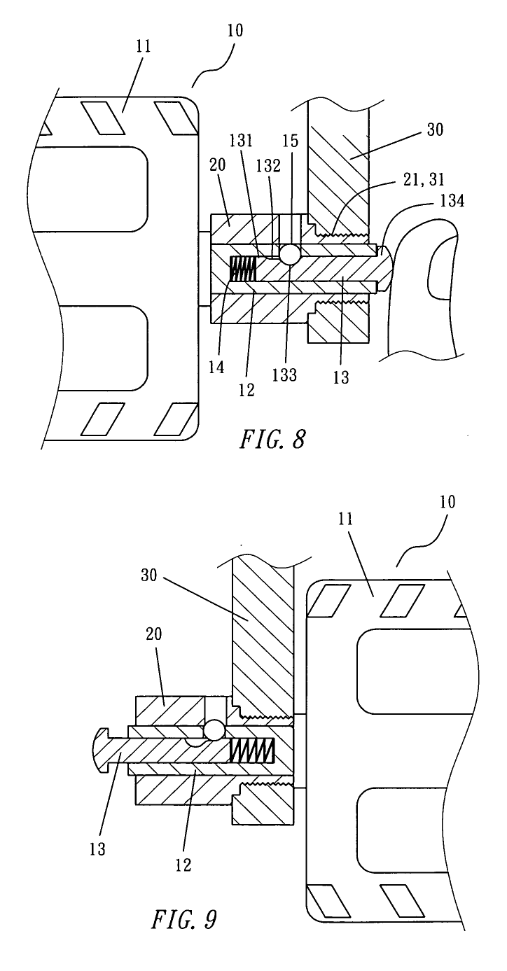

Once in the transport or stock, the pedal 10 is demounted from the bracing joint 20 to save the occupying space. The steps of operation are as follows:
1.) As in FIG. 8, by using a finger to depress the pressing head 134, the control bar 13 is moved inward, which aligns the holding notch 133 of the control bar 13 with the fixing member 15. At the moment, the fixing member 15 falls in the holding notch 133 for a stay. It is available to hold the pedal 10 for the extraction of the pivotal shaft 12 (come with the control bar 13) from the joining cylinder 22 of the bracing joint 20 to return to the state in FIG. 2.
2.) As the pivotal shaft 12 leaves the joining cylinder 22 and the control bar 13 is not being pressed, the push to the control bar 13 by the elastic force of the springy member 14 will move the control bar outward, and the elevated position 132 boosts the fixing member 15 up (shown in FIG. 2).
3.) The user then places the extracted pedal 10 in a reverse position, and inserts the pivotal shaft 12 into the internal side of the joining cylinder 22 of the bracing joint 20 (say an interior insertion mode). Follow exactly the order of the exterior insertion mode (but reverse the direction) shown in FIGS. 4-6 to accomplish the mounting that forms the state in FIG. 9.

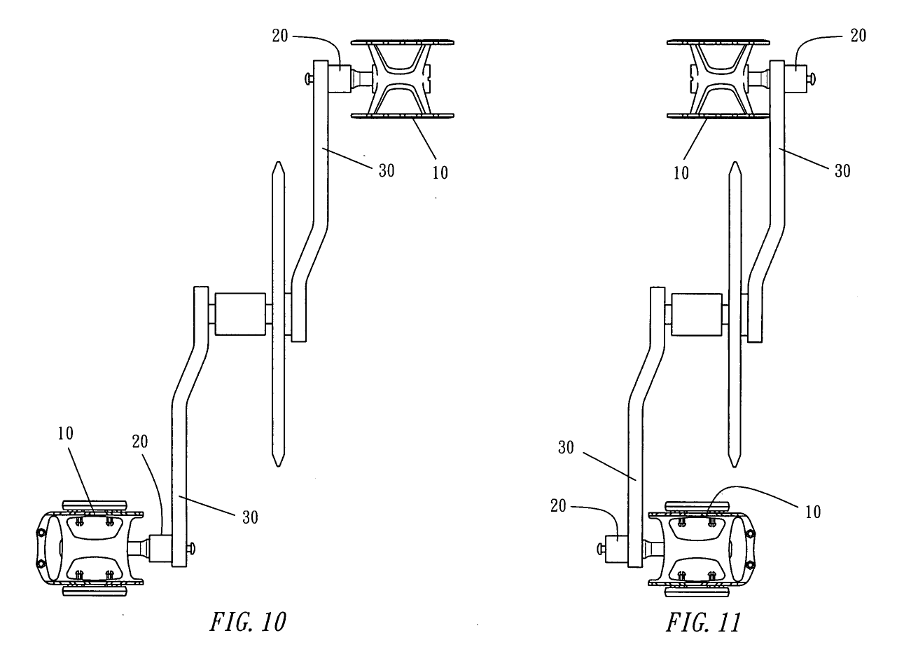

Referring to FIGS. 10 & 11, FIG. 10 represents a normal using state of the exterior insertion mode of the pedal 10, while FIG. 11 represents a stocking state of the interior insertion mode of the pedal 10. FIG. 11 shows that this invention embodiment uses the same assembly structure to store the demounted and reversed pedal 10. Because of storing in the same bike, there is no possibility to forget or lose. Since the store is located at the space between the cranks 30 of both sides, without any portion to exceed, which means deadly save the storage.

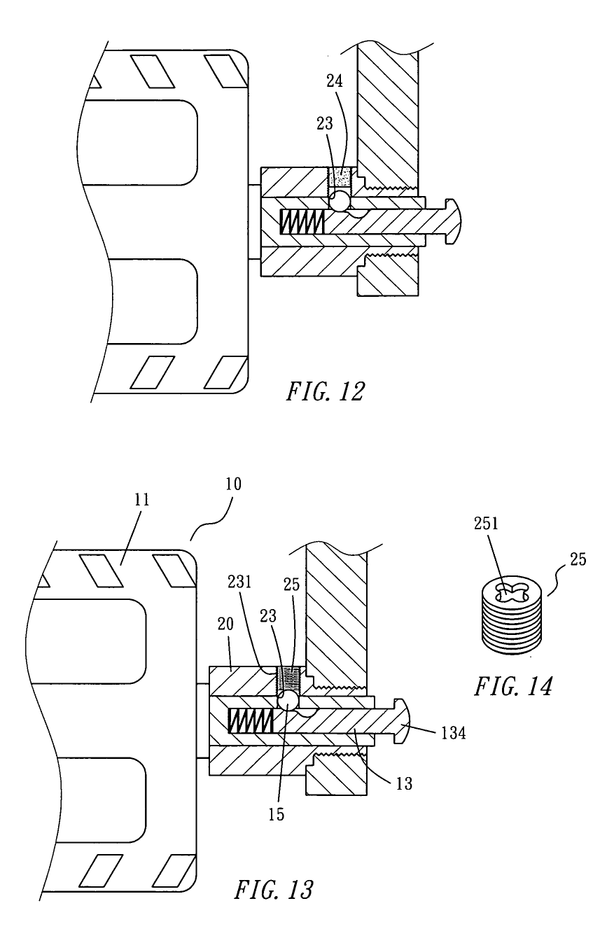

The structural combination of this invention can have multiple varieties, by referring to FIG. 12; this invention may comprise a rubber plug 24. Once the aforementioned assembly is accomplished, the plug 24 is inserted in the fixing bore 23, to prevent dusts and water to creep into the fixing bore 23.

Referring to FIGS. 13 & 14, this invention comprises an outer-threaded stopper 25, where its outer end is formed into a driving jag 251 of special shape (shown in FIG. 14). The inner wall of the fixing bore 23 is provided with inner thread 231 that ties in correspondingly with the outer thread of the stopper 25. Once the aforementioned assembly is accomplished, by using a driving tool (not shown in the figure) corresponding to the driving jag 251, the stopper 25 is being screwed in the fixing bore 23, for the inner end of the stopper 25 forcefully prop the fixing member 15, and further makes the fixing member 15 to prop the control bar 13 for an immobilizing. At this moment, even a depressing on the pressing head 134 from outside, the control bar 13 no longer move. Aside from the features of preventing dust and water creeping into the fixing bore 23, it features preventing others from dismounting the pedal 10 from the bracing joint 20. However, if the user desires to dismount the pedal 10 from the bracing joint 20, it can be accomplished simply by reversely screwing the stopper 25 until the inner end of the stopper 25 and the control bar 13 propped forcefully by the fixing member 15 is released, which means a depressing on the pressing head 134 to move the control bar 13 for the dismounting of the pedal 10 from the bracing joint 20.

Accordingly, the bike pedal assembly structure of this invention is absolutely novel to the prior art, it further features improved functionality, which is completely compliant to the requirements of patent law; the aforesaid exemplified embodiments of the present invention are only used for describing this invention, it shouldn't limit the claim of the present invention. Any equivalent embodiments or modifications without departing from the spirit and scope of the present invention are therefore intended to be embraced.

What is claimed is:

1. A bike pedal assembly structure, comprising a pedal, a bracing joint and a crank; wherein:
said pedal comprises a pedal surface, a pivotal shaft extended from a side thereto; where the pivotal shaft is provided with an inward cylindrical hollow and a fixing hole set up on its interior wall; and said pedal further comprising a control bar, a springy member and a fixing member, where the control bar is provided with an elevated position and a relatively low holding notch, and its front end being set up into a pressing head; the springy member being placed into the cylindrical hollow of the pivotal shaft first, followed by the insertion of the control bar, until a touch with the springy member, and a alignment between the fixing hole with either the elevated position or the holding notch, the fixing member being placed from the external of the fixing hole to have its bottom portion touch the elevated position or the holding notch, and an extra work being activated to shrink the opening rim of the fixing hole inward for the prevention of the fixing member from coming off the fixing hole;
said bracing joint being short cylindrical in shape, having an outer threaded section extending from its side thereto for a joining, and having a joining cylinder penetrating through its interior, where a fixing bore is set up on the internal wall;
said crank having its one end mounted on the bike, while the other end has an inner-threaded cylinder for the joining purpose;
the outer threaded section of said bracing joint being screwed into the inner threaded cylinder of said crank, and the pivotal shaft being penetrated into the joining cylinder of said bracing joint for a joining, by means of the hold by the elevated position of the control bar, the fixing member being lifted into the fixing bore of said bracing joint for later joining; by depressing the pressing head, the holding notch of the control bar being provided with a lodgment for the fixing member, which enables the dismounting of the pivotal shaft of said pedal and the control bar from the joining cylinder of said bracing joint.

2. A bike pedal assembly structure of claim 1 wherein the springy member may be a bar-shaped spring.

3. A bike pedal assembly structure of claim 1 wherein the fixing member may be a spherical steel ball.

4. A bike pedal assembly structure of claim 1 wherein the control bar is provided with a block at its bottom end.

5. A bike pedal assembly structure of claim 1 wherein the length of the joining cylinder of said bracing joint is better to accommodate completely the pivotal shaft of said pedal.

6. A bike pedal assembly structure of claim 1 wherein the fixing bore may be inserted by a plug.

7. A bike pedal assembly structure of claim 1 wherein the inner wall of the fixing bore may be set up with inner threads, followed by the screwing of an outer threaded stopper into the fixing bore, to enable the inner end of the stopper to prop tightly the fixing member, which further makes the fixing member tightly prop the control bar for an immobilizing.
